(19) United States
(12) Patent Application Publication
(10) Pub. No.: US 2010/0183013 A1
(43) Pub. Date: Jul. 22, 2010

(54) PACKET PROCESSING DEVICE AND METHOD

(75) Inventors: Tou Ieong, Taipei (TW); Sheng-De Wang, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/423,458

(22) Filed: Apr. 14, 2009

(30) Foreign Application Priority Data
Jan. 21, 2009 (TW) 098102190

(51) Int. Cl. H04L 12/56

(52) U.S. Cl. 370/394

(57) ABSTRACT

A packet processing device is provided, which is applied to a network equipment that transmits packets. The device includes: a control module for executing a control schedule; a capture module for capturing at least one packet according to the control schedule; and a disassembling module for disassembling the header of the packet according to the control schedule so as to obtain packet header information. The packet processing device of the present invention can be installed in any network equipment to disassemble and process packets before they are captured by CPUs or memories of back-end computers, thereby achieving rapid processing of packets and reducing usage of CPU resources and occupancy of memories.

### FIELD OF THE INVENTION

The present invention relates to packet processing devices and methods, and more particularly, to a packet processing device and method applied to a network equipment for packet transmission.

### BACKGROUND OF THE INVENTION

By means of Internet technology, nodes are series connected to form enormous network systems, one of which is packet switching networks.

A packet consists of a header and a body, wherein the header of the packet needs to be disassembled so as to obtain information concerning the packet delivery destination. The principle of the packet is similar to that of a conventional postal package. Recipient's name and address, weight of the package, sending and receiving dates should be labeled on the package such that a postman can deliver the package to the correct destination. Conventionally, the header of the packet is disassembled by software so as to obtain packet header information, and the packet is further sorted and/or filtered according to the packet header information.

However, the prior art has following drawbacks:

(1) occupying memory spaces. Since data needs to be stored in memories during packet switching, memory spaces are occupied.

(2) increasing the burden on CPUs (Central Processing Units). The access of memories occupies a lot of CPU resources, thereby increasing the processing time of operating systems (OS).

(3) lowering the processing speed. If operating systems need to create other critical schedules, the packet processing speed and efficiency will be reduced.

Therefore, it is desired to provide a packet processing device and method so as to achieve rapid processing of packets and reduce usage of CPU resources and occupancy of memories.

The present invention provides a packet processing device and method applied to a network equipment for packet transmission so as to overcome the drawbacks of the prior art that processes packets by software and/or hardware. The packet processing device provided by the present invention can be designed as a chip, which offers modules to execute a control schedule, capture and store a packet according to the control schedule, disassemble the header of the packet so as to obtain packet header information and then perform sorting, scanning, analyzing, comparing, filtering, and/or security protection to the packet according to the packet header information, and further verify whether the packet is authorized through stateful inspection technology.

Therefore, the packet processing device and method of the present invention achieves rapid processing of packets, and reduces usage of CPU resources and occupancy of memories, thereby overcoming the drawbacks of the prior art.

### SUMMARY OF THE INVENTION

In order to achieve the above and other objects, the present invention provides a packet processing device applied to a network equipment for packet transmission. The packet processing device comprising: a control module for executing a control schedule; a capture module for capturing at least one packet according to the control schedule; and a disassembling module for disassembling a header of the at least one packet captured by the capture module according to the control schedule so as to obtain packet header information.

The present invention further provides a packet processing method applied to a packet processing device. The packet processing method comprises the following steps of: capturing at least one packet from a network equipment; disassembling a header of the at least one packet so as to obtain packet header information; and transmitting the packet header information and the at least one packet to a user end device.

The present invention also provides a packet processing method applied to a packet processing device. The packet processing method comprises the following steps of: capturing at least one packet from a network equipment; disassembling a header of the at least one packet so as to obtain packet header information; processing the at least one packet according to the packet header information; and transmitting the packet header information, the at least one packet, and a processing result obtained from the processing of the at least one packet to a user end device.

### BRIEF DESCRIPTION OF DRAWINGS

FIG. 1 is a schematic diagram showing the basic structure of a packet processing device of the present invention;

FIG. 2 is a schematic diagram showing a packet processing device according to an embodiment of the present invention;

FIG. 3 is a schematic diagram showing a packet processing device according to another embodiment of the present invention;

FIG. 4 is a diagram showing the system architecture of the packet processing device of the present invention;

FIG. 5 is a flowchart showing a packet processing method of the present invention;

FIG. 6 is a flowchart showing a packet processing method according to an embodiment of the present invention; and

FIG. 7 is a flowchart showing a packet processing method according to another embodiment of the present invention.

### DETAILED DESCRIPTION OF THE PREFERRED EMBODIMENTS

The following illustrative embodiments are provided to illustrate the disclosure of the present invention, and these and other advantages and effects can be apparently understood by those in the art after reading the disclosure of this specification. The present invention can also be performed or applied by other different embodiments. The details of the specification may be on the basis of different applications, and numerous modifications and variations can be devised without departing from the spirit of the present invention.

The embodiments described herein are provided for further description of details of the present invention but shall not limit the scope of the present invention.

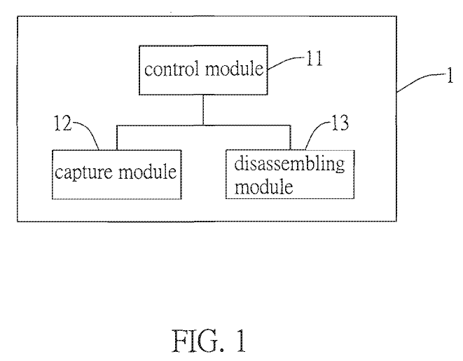

FIG. 1 shows the basic structure of a packet processing device of the present invention. As shown in FIG. 1, the packet processing device 1 of the present invention comprises a control module 11, a capture module 12, and a disassembling module 13.

The control module 11 is used to execute a control schedule. The control schedule is a preset procedure for capturing, disassembling, processing and/or storing packets.

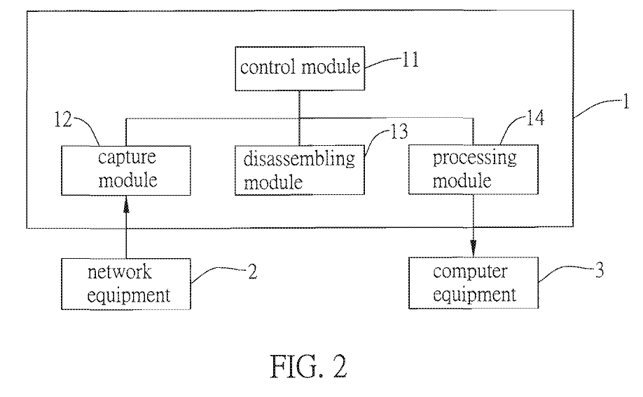

The capture module 12 captures at least one packet according to the control schedule. The capture module 12 can actively capture the packet from a network equipment 2 (FIG. 2), and the packet has a header.

The disassembling module 13 is used to disassemble the header of the packet according to the control schedule so as to obtain packet header information. The packet header information is a source IP address, a source port, a destination IP address, a destination port and/or a protocol.

In one embodiment, first, the capture module 12 actively captures a packet, then, the control module 11 transmits the packet to the disassembling module 13, subsequently, the disassembling module 13 disassembles the header of the packet so as to obtain packet header information that is further sent to a user end device.

Referring to FIG. 2, a packet processing device according to an embodiment of the present invention is shown. Compared with FIG. 1, the packet processing device 1 of the present embodiment further comprises a processing module 14, and the packet processing device 1 is connected with a network equipment 2 and a computer equipment 3.

The network equipment 2 is used as a medium to connect the computer equipment with Internet. The network equipment 2 may be a switch equipment, a transmission equipment, a broadband receiver, a wired local area network equipment, a broadband network application device, and/or a user end device, wherein the user end device could be a Modem, the wired local area network equipment could be a NIC or a Hub, and the switch equipment could be a switch or a router.

The computer equipment 3 is a general digital data processing device, such as a personal computer or a server.

The processing module 14 processes the packet according to the packet header information according to the control schedule. The processing module 14 performs sorting, scanning, analyzing, comparing, filtering, and/or security protection to the packet according to the packet header information. And the processing module 14 can also sort the packet through a network flow, and verifies whether the packet is authorized through stateful inspection technology.

In one embodiment, first, the capture module 12 actively captures a packet from the network equipment 2. The control module 11 subsequently sends the packet to the disassembling module 13 such that the disassembling module 13 disassembles the header of the packet so as to obtain packet header information. Thereafter, the processing module 14 performs sorting, scanning, analyzing, comparing, filtering and/or security protection to the packet according to packet header information.

In the above-mentioned embodiment, the capture module 12 captures one packet at a time. After the header of the packet is disassembled and the packet is processed, the control module 11 sends a request to the capture module 12 such that the capture module 12 captures another new packet from the network equipment 2.

Thus, the packet processing device of the present invention performs an initial processing to a packet before it enters into a user end computer, thereby lowering the burden on the CPU and OS. From the embodiments mentioned above, it is understood that the packet processing device provided by the present invention achieves rapid processing of packets without the need of any computer equipment.

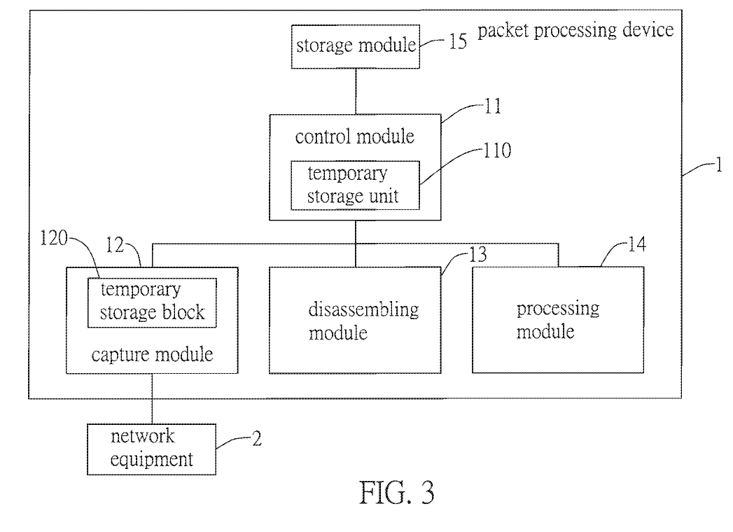

FIG. 3 is a diagram showing a packet processing device according to another embodiment of the present invention. As shown in FIG. 3, the data processing device 1 is applied to a network equipment 2. The data processing device 1 comprises a control module 11, a capture module 12, a disassembling module 13, a processing module 14, a storage module 15, a temporary storage unit 110, and a temporary storage block 120, wherein the functions of the network equipment 2, the control module 11, the capture module 12, the disassembling module 13, and the processing module 14 have been described above, and will not be repeated herein; only the storage module 15, the temporary storage unit 110, and the temporary storage block 120 will be elaborated.

The temporary storage block 120 is disposed in the capture module 12 for storing a plurality of packets captured by the capture module 12 from the network equipment 2.

The temporary storage unit 110 is disposed in the control module 11 for storing certain number of packets obtained by the control module 11 from the packets stored in the temporary storage block 120.

The storage module 15 is used for storing packets and/or packet header information.

In one embodiment, the capture module 12 actively captures a first number of packets from the network equipment 2 and stores them into the temporary storage block 120 to await another packet request from the control module 11, and the control module 11 acquires a second number of packets from the first number of the packets stored in the temporary storage block 120 and stores them into the temporary storage unit 110 and the storage module 15, wherein the first number is greater than the second number. Next, the disassembling module 13 selects a packet in order from the second number of the packets stored in the temporary storage unit 110 and disassembles the header of the packet so as to obtain packet header information. And the control module 11 stores the packet header information into the storage module 15. Next, the processing module 14 performs sorting, scanning, analyzing, comparing, filtering, and/or security protection to the packet according to the packet header information, and verifies whether the packet is authorized through stateful inspection technology. Finally, the control module 11 stores the processing result of the processing module 14 into the storage module 15.

The effects achieved by adding the temporary storage block 120 and temporary storage unit 110 lie in decreasing the time that the control module 1 awaits the capture module 12 to capture a packet from the network equipment 2, and enabling the disassembling module 13 and the processing module 14 to simultaneously execute the disassembling schedule and the processing schedule.

For instance, the capture module 12 may capture ten packets at a time from the network equipment 2 and store the ten packets into the temporary storage block 120 to wait for a new packet request from the control module 11. Next, the control module 11 captures four packets from the ten packets stored in the temporary storage block 120, and stores them into the temporary storage unit 110 and the storage module 15. Then, the disassembling module 13 selects a packet from the four packets stored in the temporary storage unit 110 and disassembles the header of the packet so as to obtain packet header information. And the control module 11 stores the packet header information into the storage module 15 (at this time, the number of the packets in the temporary storage unit 110 changes from four to three, and the number of the packets in the temporary storage block 120 changes from ten to six, as a result, the control module 11 will capture one packet from the six packets in the temporary storage block 120 so as to keep the number of the packets in the temporary storage unit 110 at four). Afterward, the processing module 14 processes the packet according to the packet header information, and the control module 11 stores the processing result of the processing module 14 into the storage module 15. (At this time, the disassembling module 13 again selects one packet from the four packets stored in the temporary storage unit 110 and disassembles the header of the packet so as to obtain packet header information).

In other words, the control module 11 continuously obtains packets from the packets stored in the temporary storage block 120 so as to keep the number of the packets in the temporary storage unit 110 at four. When the number of the packets in the temporary storage block 120 is reduced to zero, the capture module 12 will further capture ten packets from the network equipment 2 and store them into the temporary storage block 120 to await the control module 11 to request a new packet. The upper limit of the number of the packets in the temporary storage unit 110 increases with the number of the modules that perform schedules to the packets stored in the temporary storage unit 110. For example, in the present embodiment, the modules that perform schedules to the packets stored in the temporary storage unit 110 include the disassembling module and the processing module, and the upper limit of the number of the packets stored in the temporary storage unit 110 is four. If the modules performing scheduling to the packets stored in the temporary storage unit 110 include the disassembling module, sorting module, and filtering module, the upper limit of the number of the packets of the temporary storage unit 110 increases to 6. Similarly, the upper limit of the number of the packets stored in the temporary storage block 120 is preferred to be ten or more.

In the embodiment, the temporary storage block 120 and the temporary storage unit 110 are added to the device. As a result, when the control module 11 requests a new packet, it can instantly obtain a packet from the temporary storage block 120 without the need to await the capture module 12 to capture a packet from the network equipment 2. Besides, when the processing module 14 processes the packet according to the packet header information, the disassembling module 13 can, at the same time, select a next packet from the certain number of packets of the temporary storage unit 110 and disassemble the packet so as to obtain packet header information. By making the disassembling schedule of the disassembling module 13 and the processing schedule of the processing module 14 be performed in parallel, the packet processing can be speeded up. Besides, the required upper limit of the number of packets in the temporary storage unit 110 only needs to be twice of the number of the modules performing schedules to the packets in the temporary storage unit (the disassembling module and/or the processing module for example). Therefore, the storage space does not need to be large.

Therefore, the packet processing device of the present invention achieves rapid processing speed, reduces occupancy of memories and reduces burden on CPUs.

Therefore, the packet processing device of the present invention can process packets efficiently without the need of computer equipments.

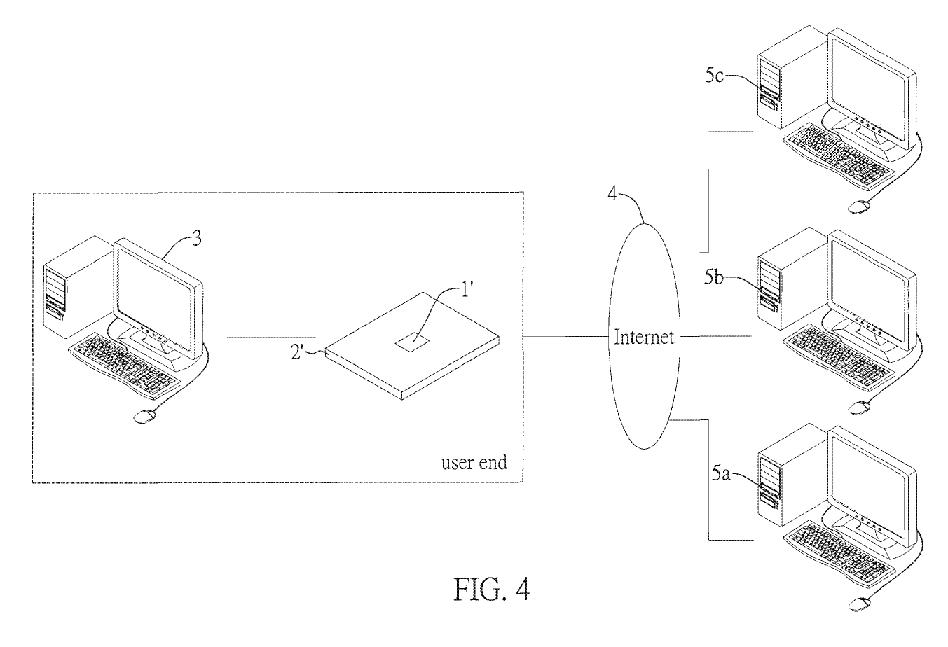

FIG. 4 shows the system architecture of the packet processing device of the present invention. The user end is a computer 3 and a modem 2′. A packet processing chip 1′ is installed to the modem 2′. The computer 3 is connected to Internet 4 through the modem 2′ installed with the packet processing chip 1′. A first server 5a, a second server 5b, and a third server 5c transmit a large number of packets to the user end via Internet 4. The packet processing chip 1′ actively captures a packet from the modem 2′, and disassembles the header of the packet so as to obtain information such as a source IP address, a source port, a destination IP address, a destination port and/or a protocol. Then, according to the information, the packet is processed by performing sorting, scanning, analyzing, comparing, filtering and/or security protection. In the present embodiment, packets have been pre-processed by the packet processing chip 1′ before flowing into the computer 3, thereby significantly reducing the burden on CPU and OS and improving the packet processing efficiency of the user end.

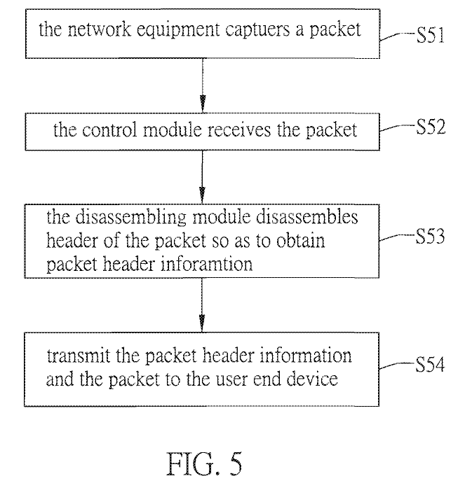

FIG. 5 is a flowchart of a packet processing method of the present invention. As shown in FIG. 5, the packet processing method is applied to a packet processing device comprising a control module, a capture module, and a disassembling module. The packet processing method comprises the following steps.

In step S51, the capture module captures a packet from a network equipment. The capture module will actively capture the packet from the network equipment. The network equipment may be a modem, a NIC, a HUB, a switch, a router and/or a firewall. Then, the process goes to step S52.

In step S52, the control module receives the packet for executing a control schedule, which comprises a capture schedule, a disassembling schedule, a processing schedule and/or a storage schedule. Then, the process goes to step S53.

In step S53, the disassembling module disassembles the header of the packet so as to obtain packet header information. The packet header information may be a source IP address, a source port, a destination IP address, a destination port and/or a protocol. Then, the process goes to step S54.

In step S54, the packet header information and the packet are transmitted to a user end device.

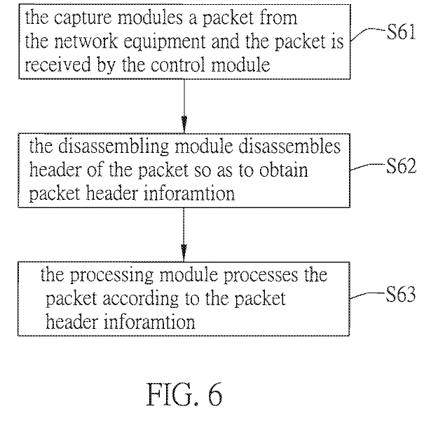

FIG. 6 shows a packet processing method according to an embodiment of the present invention. Different from FIG. 5, the packet processing device of the present embodiment further comprises a packet processing module. The packet processing method of the present embodiment comprises the following steps.

In step S61, the capture module captures a packet from a network equipment and the packet is received by the control module. Then, the process goes to step S62.

In step S62, the disassembling module disassembles the header of the packet so as to obtain packet header information. Then, the process goes to step S63.

In step S63, the processing module processes the packet according to the packet header information. The processing module can perform sorting, scanning, analyzing, comparing, filtering and/or security protection to the packet according to the packet header information. In one preferred embodiment, the processing module executes sorting of the packet according to the packet header information through network flow, and verifies whether the packet is authorized through stateful inspection technology.

Therefore, the packet processing method offered by the present invention reduces the memory occupancy and CPU burden.

It is to be understood from the embodiment that the present invention provides a packet processing method that can rapidly process packets without the need of any computer equipment.

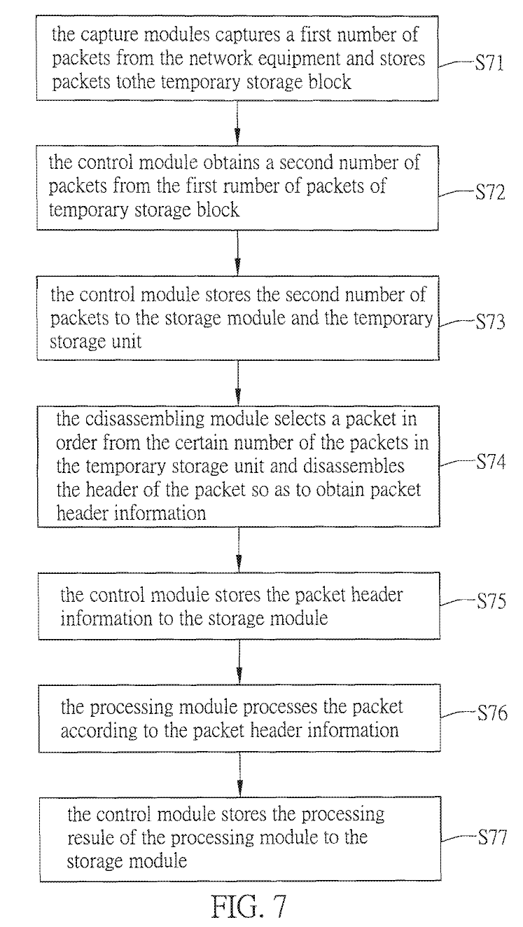

FIG. 7 shows a packet processing method according to another embodiment of the present invention. The packet processing method is applied to a packet processing device that comprises a control module, a capture module, a disassembling module, a processing module, a storage module, a temporary storage unit, and a temporary storage block. The packet processing method comprises the following steps.

In step S71, the capture module captures a first number of packets from a network equipment and stores them into the temporary storage block. Then, the process goes to step S72.

In step S72, the control module obtains a second number of packets from the first number of the packets stored in the temporary storage block. Then, the process goes to step S73.

In step S73, the control module stores the second number of the packets into the storage module and the temporary storage unit. Then, the process goes to step S74.

In step S74, the disassembling module selects a packet from the second number of the packets stored in the temporary storage unit and disassembles the header of the packet so as to obtain packet header information. Then, the process goes to step S75.

In step S75, the control module stores the packet header information into the storage module. Then, the process goes to step S76.

In step S76, the processing module processes the packet according to the packet header information. The processing module can perform sorting, scanning, analyzing, comparing, filtering and/or security protection to the packet according to the packet header information.

Finally, in step S77, the control module stores the processing result of the processing module into the storage module, wherein the control module will continuously obtain packets from the first number of the packets stored in the temporary storage block so as to keep the number of the packets in the temporary storage unit at the upper limit.

Thus, the present embodiment can be applied to process a plurality of packets, achieves rapid processing speed, and reduces the CPU burden and memory occupancy. Moreover, the packets can be rapidly processed without the need of any computer equipment.

The foresaid packet processing device and method achieve the following effects,

(1) reducing the CPU burden and memory occupancy. The packet processing device and method of the present invention allow the packets to be processed before flowing into back-end computers, thereby reducing the CPU and OS burden and memory occupancy.

(2) increasing the packet processing speed. The packet processing device of the present invention are installed with many modules for temporarily storing a plurality of packets and simultaneously processing the plurality of the packets so as to avoid a waste of time in awaiting the packet processing device to capture packets from a network equipment.

The foregoing descriptions of the detailed embodiments are illustrated to disclose the features and functions of the present invention and are not intended to be restrictive of the scope of the present invention. It should be understood to those in the art that various modifications and variations performed according to the spirit and principles in the disclosure of the present invention fall within the scope of the appended claims.

What is claimed is:

1. A packet processing device applied to a network equipment for packet transmission, the device comprising:
a control module for executing a control schedule;
a capture module for capturing at least one packet according to the control schedule; and
a disassembling module for disassembling a header of the at least one packet captured by the capture module according to the control schedule so as to obtain packet header information.

2. The device of claim 1, further comprising a processing module for processing the at least one packet based on the packet header information according to the control schedule.

3. The device of claim 2, wherein the capture module further comprises a temporary storage block for storing a first number of packets, and the control module further comprises a temporary storage unit for storing a second number of packets, the first number being greater than the second number,
wherein the capture module captures the first number of the packets from the network equipment and stores them into the temporary storage block, and the control module acquires the second number of the packets from the temporary storage block and stores them into the temporary storage unit, allowing the disassembling module to select the at least one packet in order from the second number of the packets so as to disassemble the header of the at least one packet to thereby obtain the packet header information, whereby the processing module processes the at least one packet according to the packet header information.

4. The device of claim 2, wherein the processing module processes the packet according to the packet header information so as to obtain a processing result.

5. The device of claim 4, further comprising a storage module for storing the at least one packet, the packet header information of the packet, and/or the processing result from the processing module.

6. The device of claim 2, wherein the processing module performs sorting, scanning, analyzing, comparing, filtering, and/or security protection to the at least one packet according to the packet header information.

7. The device of claim 2, wherein the processing module processes the at least one packet according to the packet header information through a network flow, and verifies whether the at least one packet is authorized through stateful inspection technology.

8. The device of claim 1, wherein the network equipment is a Modem, a NIC, a HUB, a switch, and/or a router.

9. The device of claim 1, wherein the capture module captures the at least one packet from the network equipment.

10. The device of claim 1, wherein the packet header information is a source IP address, a source port, a destination IP address, a destination port and/or a protocol.

11. A packet processing method applied to a packet processing device, the method comprising steps of:
capturing at least one packet from a network equipment;
disassembling a header of the at least one packet so as to obtain packet header information; and
transmitting the packet header information and the at least one packet to a user end device.

12. The method of claim 11, wherein the packet header information is a source IP address, a source port, a destination IP address, a destination port and/or a protocol.

13. A packet processing method applied to a packet processing device, the method comprising steps of:
capturing at least one packet from a network equipment;
disassembling a header of the at least one packet so as to obtain packet header information;
processing the at least one packet according to the packet header information; and
transmitting the packet header information, the at least one packet, and a processing result obtained from the processing of the at least one packet to a user end device.

14. The method of claim 13, wherein the capturing of the at least one packet further comprises:
capturing a first number of packets from the network equipment and storing them into a temporary storage block;
obtaining a second number of packets from the first number of the packets stored in the temporary storage block; and
storing the second number of the packets into a temporary storage unit and a storage module,
and the disassembling of the header of the at least one packet further comprises:
selecting the at least one packet from the second number of the packets stored in the temporary storage unit and disassembling the header of the at least one packet so as to obtain the packet header information; and
storing the packet header information into the storage module, and the first number is greater than or equal to the second number.

15. The method of claim 14, wherein the transmitting further comprises storing the processing result into the storage module.

16. The method of claim 13, wherein the packet header information is a source IP address, a source port, a destination IP address, a destination port and/or a protocol.

17. The method of 14, wherein the processing of the at least one packet according to the packet header information involves sorting, scanning, analyzing, comparing and/or security protection.
